(19) United States
(12) Patent Application Publication
(10) Pub. No.: US 2006/0137208 A1
(43) Pub. Date: Jun. 29, 2006

(54) Complex type drying apparatus

(75) Inventors: Deug Hee Lee, Gimhae-si (KR); Hung Myong Cho, Jillye-myeon (KR); Byung Hwan Ahn, Gimhae-si (KR); Soung Bong Choi, Changwon-si (KR); Young Soo Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngdungpo-gu (KR)

(21) Appl. No.: 11/289,630

(22) Filed: Nov. 30, 2005

(30) Foreign Application Priority Data
Nov. 30, 2004 (KR) 10-2004-99135
Nov. 30, 2004 (KR) 10-2004-99136

(51) Int. Cl. F26B 11/02; F26B 25/06

(52) U.S. Cl. 34/130; 34/201

(57) ABSTRACT

A complex type drying apparatus is disclosed, by which air can be continuously circulated through a drying drum and a cabinet to dry a laundry and by which the laundry within the cabinet can be evenly dried. The present invention includes a drum type dryer including a drum accommodating a laundry, a hot air supply pipe guiding a hot air to an inside of the drum, and a hot air supply unit provided to a pipe path of the hot air supply pipe to generate the hot air, a cabinet dryer provided over the drum type dryer, the cabinet dryer including an accommodating space for accommodating a laundry and a hot air inlet pipe supplied with the hot air from the hot air supply pipe to guide the received hot air to the accommodating space, and at least one lathe provided within the cabinet dryer, the at least one lathe having a passage for supplying the hot air to a lower side of the laundry placed on the at least one lathe.

This application claims the benefit of the Korean Patent Application Nos. P2004-99135 and P2004-99136, both filed on Nov. 30, 2004 which are hereby incorporated by references as if fully set forth herein.

### BACKGROUND OF THE INVENTION

1. Field of the Invention

The present invention relates to a dryer, and more particularly, to a complex type drying apparatus. Although the present invention is suitable for a wide scope of applications, it is particularly suitable for being provided as a built-in type by enabling air for drying a laundry to keep circulating within the dryer, for preventing a variation of an indoor environment by keep circulating air, and for enhancing drying performance.

2. Discussion of the Related Art

Generally, a dryer is an apparatus for drying a laundry such as clothes and the like. And, the dryer keeps supplying hot air to a washed laundry accommodated therein to perform a drying process of the accommodated laundry.

FIG. 1 is a cross-sectional diagram of a drum type dryer according to a related art.

Referring to FIG. 1, a drum type dryer according to a related art mainly consists of a body 10, a drying drum 20, a door 40, a motor 50, a drying heater 60 and a blower fan 70.

The body 10 configures an exterior of the drum type dryer. And, the drying drum 20 is rotatably provided within the body 10.

An entrance 11 is provided to a front side of the body 10. And, the door 40 is provided to open/close the entrance 11.

The motor 50 is fixed to an inner bottom of the body 10 to generate a drive force to rotate the drying drum 20 and the bower fan 70.

The drying heater 60 is provided within a hot air supply passage 91 to heat air flowing through the hot air supply passage 91. In doing so, the hot air supply passage 91 guides a flow of hot air supplied to an inside of the drying drum 20.

The blower fan 70 is operated to discharge dry air flowing within the drying drum 10 to outside and communicates with a hot air discharge passage 92.

Hence, once the blower fan 70 is activated, external air is guided by the hot air supply passage 91, passes through the drying heater 60 to be heated, and is then introduced into the drying drum 10.

So, a wet laundry put in the drying drum 10 is dried by the heated external air.

The air flowing through the drying drum 10 to dry the laundry is then guided by the hot air discharge passage 92 to be discharged outside the body 10.

After completion of drying the laundry by the repetitive operations of the above-explained process, the blower fan 70 and the drying heater 60 stop being driven to terminate a drying cycle.

Yet, as the laundry is collectively put in the related art dryer to carry out the drying process, an entangled portion of the laundry has difficulty in being smoothly dried.

And, it is impossible to keep the laundry within the dryer for a considerably long time.

The demand for a new dryer enabling its expanded drying capacity a long-term keeping of laundry has risen. And, a complex drum type dryer having a separate drying cabinet was disclosed in U.S. Patent Application Laid-Open No. US2004/0194339 A1 or US2004/0154194 A1.

In the complex type dryer, a space for accommodating various laundries is provided to a general drum type dryer having a rotatable drum. And, a drying cabinet is provided to the complex type dryer to be supplied with hot air.

The drying cabinet is supplied with the hot air from the drum type dryer to dry the laundry and the like accommodated therein or keeps the laundry accommodated therein for a long term.

However, the above-explained complex type dryer has an exhaust type structure enabling air, which has dried a laundry, to be discharged outside the dryer. If the hot and humid air is discharged into an indoor space, indoor air becomes hot and humid. Hence, the complex type dryer is not suitable for a built-in type.

In case that the complex type dryer having the exhaust structure is provided as a built-in type, the dryer needs to be spaced sufficiently apart from a wall surface to discharge air smoothly. Hence, an exterior design is degraded. And, it is disadvantageous in aspect of space utilization.

Moreover, since limitation is put on a position of supplying hot air to a laundry placed on a lathe or hanger provided to the drying cabinet, a portion of the laundry is excessively dried, while another portion of the laundry has difficulty in being dried. Hence, drying performance is degraded. And, the laundry may be excessively dried to be damaged.

### SUMMARY OF THE INVENTION

Accordingly, the present invention is directed to a complex type drying apparatus that substantially obviates one or more problems due to limitations and disadvantages of the related art.

An object of the present invention is to provide a complex type drying apparatus, by which air can be continuously circulated through a drying drum and a cabinet to dry a laundry and by which the laundry within the cabinet can be evenly dried.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a complex type drying apparatus according to the present invention includes a drum type dryer including a drum accommodating a laundry, a hot air supply pipe guiding a hot air to an inside of the drum, and a hot air supply unit provided to a pipe path of the hot air supply pipe to generate the hot air, a cabinet dryer provided over the drum type dryer, the cabinet dryer including an accommodating space for accommodating a laundry and a hot air inlet pipe supplied with the hot air from the hot air supply pipe to guide the received hot air to the accommodating space, and at least one lathe provided within the cabinet dryer, the at least one lathe having a passage for supplying the hot air to a lower side of the laundry placed on the at least one lathe.

Preferably, the at least one lathe includes a body part having a space portion to be supplied with the hot air via the hot air inlet pipe, the body part forming an exterior of the at least one lathe and a multitude of hot air outtakes provided to an upper side of the body part to blow the hot air supplied to the space portion.

More preferably, the body part includes an opening provided to a rear side to enable the hot air to be supplied to the space portion via the hot air inlet pipe.

More preferably, the at least one lathe further includes a supplementary hot air supply pipe provided to one end of the body part to detachably fix the at least one lathe to an inside of the cabinet dryer and to be supplied with a portion of the hot air via the hot air inlet pipe.

More preferably, the supplementary hot air supply pipe communicates with the space portion of the body part.

More preferably, at least one supplementary hot air outtake is provided to a circumference of the supplementary hot air supply pipe to blow the supplied hot air.

More preferably, the at least one lathe further includes a multitude of lower hot air outtakes provided to a lower side of the body part to downwardly blow the hot air having been supplied to the space portion.

Preferably, the at least one lathe includes a body part forming a exterior of the at least one lathe and a multitude of projections projected from an upper surface of the body part to have the laundry spaced apart from the upper surface of the body part to form a passage for supplying the hot air to the lower side of the laundry.

More preferably, the at least one lathe further includes a supplementary hot air supply pipe provided to one end of the body part to detachably fix the at least one lathe to an inside of the cabinet dryer and to be supplied with a portion of the hot air via the hot air inlet pipe.

More preferably, at least one supplementary hot air outtake is provided to a circumference of the supplementary hot air supply pipe to blow the supplied hot air.

In another aspect of the present invention, a complex type drying apparatus includes a drum type dryer including a drum accommodating a laundry, a hot air supply pipe guiding a hot air to an inside of the drum, a hot air supply unit provided to a pipe path of the hot air supply pipe to generate the hot air, and an air condensing unit provided to the pipe path of the hot air supply pipe, the air condensing unit condensing a flowing air to dissipate heat of the condensed air, a cabinet dryer provided over the drum type dryer, the cabinet dryer including an accommodating space for accommodating a laundry, a hot air inlet pipe supplied with the hot air from the hot air supply pipe to guide the received hot air to the accommodating space, and an air outlet pipe guiding an air discharged from the accommodating space to the hot air supply pipe, and at least one lathe provided within the cabinet dryer, the at least one lathe having a passage for supplying the hot air to a lower side of the laundry placed on the at least one lathe.

Preferably, the hot air supplying unit includes a drying heater heating the air flowing through the pipe path of the hot air supply pipe and a blower fan forcibly blowing the air within the hot air supply pipe.

More preferably, the blower fan is provided to an air intake side pipe path of the drying heater among the pipe paths of the hot air supply pipe by taking an air flowing direction as a reference.

Preferably, the air condensing unit includes a condenser supplied with the hot air from the hot air supply pipe to condense the hot air flowing through an inner pipe path of the condenser and a condensing fan blowing an external air toward the condenser.

Preferably, the at least one lathe includes a body part having a space portion to be supplied with the hot air via the hot air inlet pipe and to form an exterior of the at least one lathe and a multitude of hot air outtakes provided to an upper side of the body part to blow the hot air supplied to the space portion.

More preferably, the body part includes an opening provided to a rear side to enable the hot air to be supplied to the space portion via the hot air inlet pipe.

More preferably, the at least one lathe further includes a supplementary hot air supply pipe provided to one end of the body part to detachably fix the at least one lathe to an inside of the cabinet dryer and to be supplied with a portion of the hot air via the hot air inlet pipe.

More preferably, the supplementary hot air supply pipe communicates with the space portion of the body part.

More preferably, at least one supplementary hot air outtake is provided to a circumference of the supplementary hot air supply pipe to blow the supplied hot air.

Preferably, the at least one lathe includes a body part forming a exterior of the at least one lathe and a multitude of projections projected from an upper surface of the body part to have the laundry spaced apart from the upper surface of the body part to form a passage for supplying the hot air to the lower side of the laundry.

Accordingly, the above-explained dryer having the lathe provides the following effects or advantages.

First of all, since the air flowing through the drum type dryer and the cabinet dryer is continuously circulated without being discharged outside, an indoor environment remains intact. Hence, the present invention is suitable for a built-in type.

Secondly, since the humid air discharged from the drum type and cabinet dryers is condensed by the air condenser, the moisture is removed from the humid air. Hence, the present invention enables the laundry to be smoothly dried.

Thirdly, as the hot air drying lathe is provided within the cabinet dryer, the present invention can dry the laundry evenly and can reduce a drying time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a drum type dryer according to a related art;

FIG. 2 is a front diagram of a complex type drying apparatus according to an embodiment of the present invention;

FIG. 3 is a cross-sectional diagram taken along a cutting line I-I in FIG. 2;

FIG. 4 is a schematic block diagram of a complex type drying apparatus according to an embodiment of the present invention;

FIG. 5 is a perspective diagram of a lathe according to an embodiment of the present invention;

FIG. 6 is a perspective diagram of the lathe viewed in a direction of ‘A’ in FIG. 5;

FIG. 7 is a cross0setional diagram of the lathe taken along a cutting line II-II in FIG. 5;

FIG. 8 is a perspective diagram of a lathe according to another embodiment of the present invention; and

FIG. 9 is a cross0setional diagram of the lathe taken along a cutting line III-III in FIG. 8.

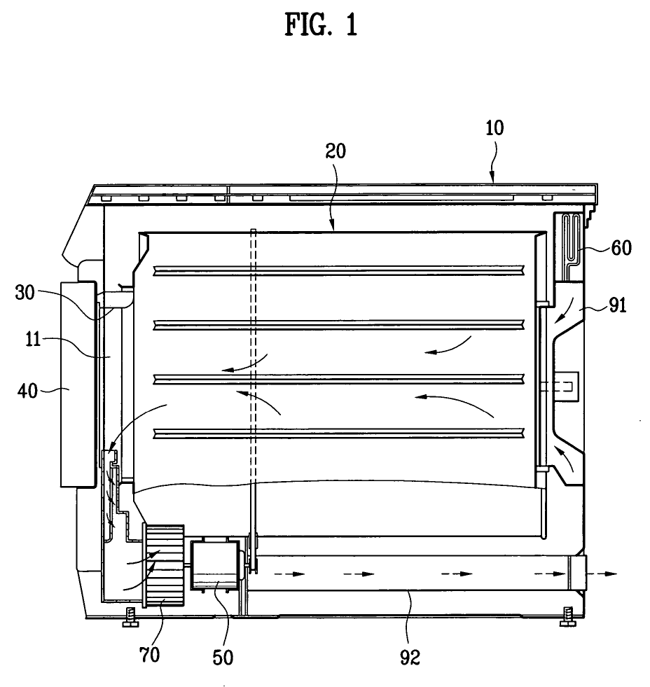

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

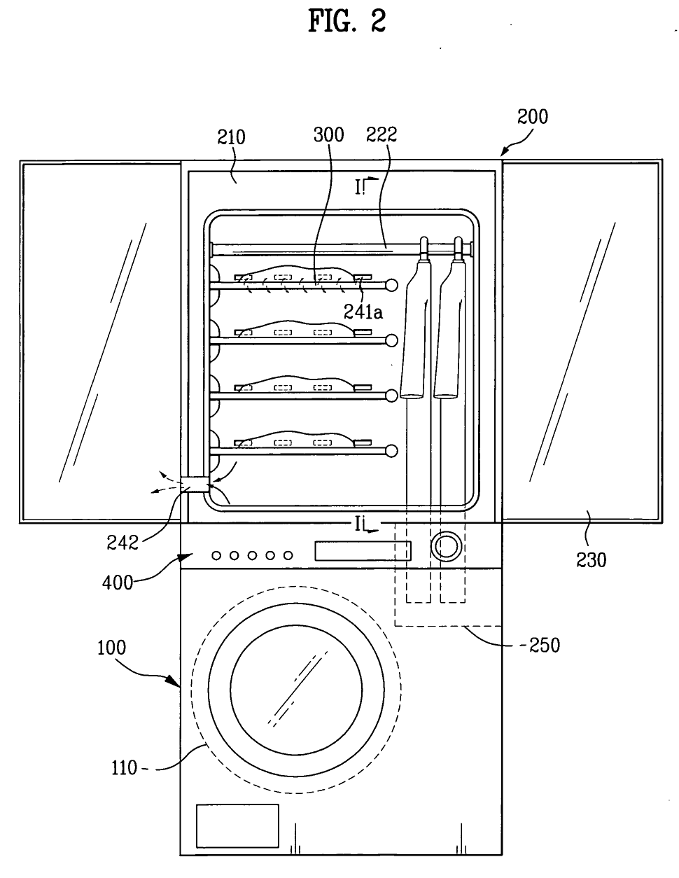

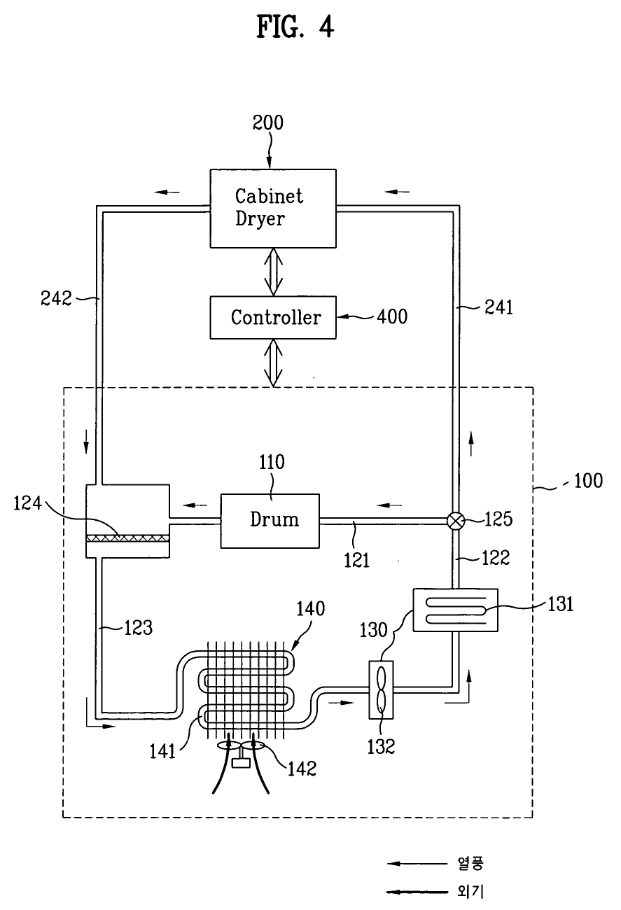

A drying apparatus according to a preferred embodiment of the present invention is explained in detail with reference to FIGS. 2 to 7 as follows.

Referring to FIGS. 2 to 4, a drying apparatus according to an embodiment of the present invention includes a drum type dryer 100, a cabinet dryer 200, a lathe 300 and a control unit 400.

The drum type dryer 100 performs a drying process on a laundry only. And, the drum type dryer 100 includes a drying drum 110 enabling a rotation and agitation, a hot air supply pipe, a hot air supply unit 130 and an air condensing unit 140.

The hot air supply pipe is a pipe that guides a flow of hot air and communicates with the drying drum 110 and an inner space between the air condensing unit 140 and the cabinet dryer 200.

The hot air supply pipe includes a first supply pipe 121 supplying hot air to an inside of the drying drum 110, a second supply pipe 122 receiving air via the air condensing unit 140 to supply to the first supply pipe 121, and a third supply pipe 123 receiving air discharged from the drying drum 110 to transfer to the air condensing unit 140.

Preferably, a filter unit 124 is provided to a path of the third supply pipe 123 to filter off particles including in the flowing air.

The hot air supply unit 130 is provided to a path of the second supply pipe 122 to generate hot air.

The hot air supply unit 130 includes a drying heater 131 heating the air flowing through the second supply pipe 122 of the hot air supply pipe and a blower fan 132 forcibly blowing the air within the second supply pipe 122.

Preferably, the blower fan 132 is provided to a path of the second supply pipe 122 in the vicinity of one side of the drying heater 131 into which the air is introduced. This is to minimize the damage caused to the blower fan 132 by the hot air.

The air condensing unit 140 includes a condenser 141 and a condensing fan 142. And, the air condensing unit 140 condenses the air flowing through the hot air supply pipe to dissipate heat of the air.

The condenser 141 is configured to be supplied with the hot air from the third supply pipe 123 of the hot air supply pipe. And, the condenser 141 may include a multiply bent pipe and a plurality of cooling fins.

And, the condensing fan 142 may be configured to blow external air toward the condenser 141.

Hence, the hot and humid air, which is flowing through a pipe path of the condenser 141 to pass through the condenser 141, is condensed by undergoing heat exchange with the external air provided by the driven condensing fan 142 so that the dehumidified air at low temperature can flow to the hot air supply unit 130.

Meanwhile, the cabinet dryer 200 includes an accommodating space for accommodating a plurality of laundries therein and is provided over the drum type dryer 100.

The cabinet dryer 200 includes a body 210, an opening/closing door 230, a hot air inlet pipe 241 and an air outlet pipe 242.

The body 210 forms an exterior of the cabinet dryer 200. A front side of the body 210 is open if the opening/closing door 230 is opened. And, an accommodating space for accommodating a plurality of laundries therein is formed within the body 21.

Preferably, the body 210 includes an extension portion 250 extending to the inside of the drum type dryer 100. In particular, the accommodating space of the body 210 is increased by the extension portion 250.

The extension portion 250 enables a long laundry such as pants, coats and the like to be hung without being folded. More preferably, the extension portion 250, as shown in FIG. 2, is provided in the vicinity of one side of the drum type dryer 100 not to affect a rotation of the drying drum 110 of the drum type dryer.

One end of the hot air inlet pipe 241 is connected to an outgoing path of the second supply pipe 122 of the hot air supply pipe of the drum type dryer 100, while the other end of the hot air inlet pipe 241 is connected to communicate with an inside of the body 210. Hence, the hot air inlet pipe 241 plays a role in being supplied with the hot air from the second supply pipe 122 of the hot air supply pipe to provide to the accommodating space within the body 210.

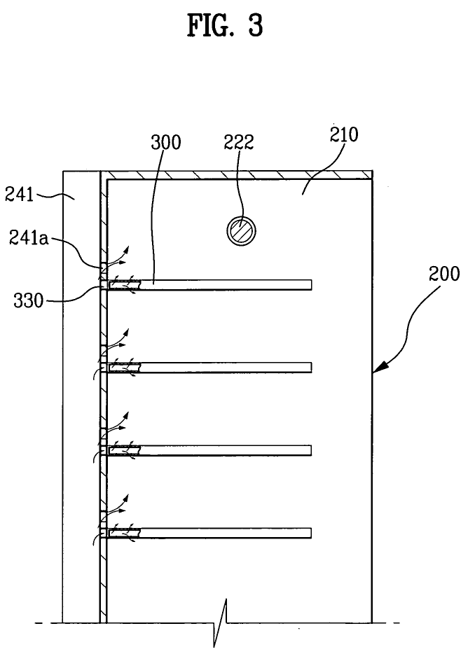

Preferably, a plurality of hot air outlets 241a, as shown in FIG. 3, are provided to a pipe path of the hot air inlet pipe 241 to communicate with the inside of the body 210 of the cabinet dryer.

Preferably, a passage valve 125 is provided to a pipe path of the second supply pipe 122 to selectively guide a flowing direction of the air to the first supply pipe 121 and/or to the hot air inlet pipe 241.

Namely, by appropriately controlling the passage valve 125, one of the dryers is used or both of the dryers are used. Hence, the drying process can be effectively carried out.

One end of the air outlet pipe 242 is connected to communicate with the body 210, while the other end of the air outlet pipe 242 is connected to the third supply pipe 123 of the hot air supply pipe. Hence, the air outlet pipe 242 plays a role in discharging hot and humid air having passed through the laundry within the body 210.

The air discharged via the air outlet pipe 242 is condensed again to be provided to the drum 110 of the drum type dryer or the accommodating space within the body 210 of the cabinet dryer. Hence, the air circulates within the complex type drying apparatus.

Namely, the complex type drying apparatus according to the present invention prevents the hot and humid air through the laundry from being discharged outside, whereby the air-conditioned state of the indoor space can avoid being changed.

And, the lathe 300 supports the laundries and directly supplies the hot air supplied to the inside of the body 210 of the cabinet dryer to the laundries. Hence, the laundries can be more smoothly dried.

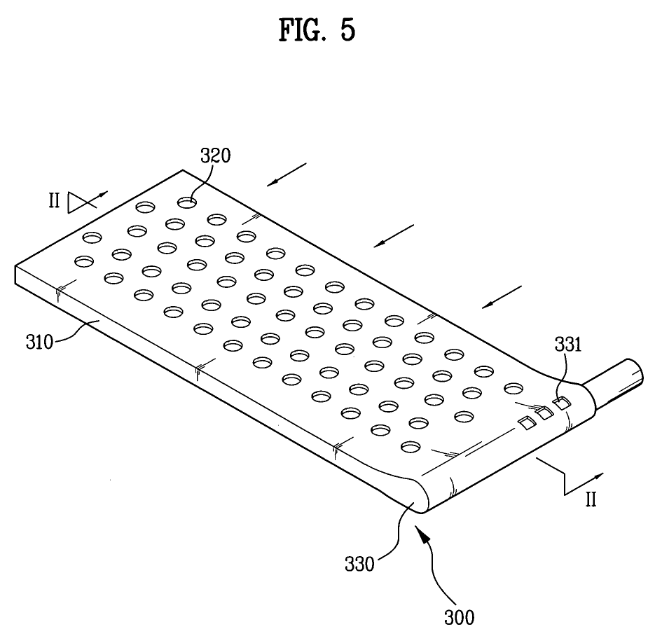

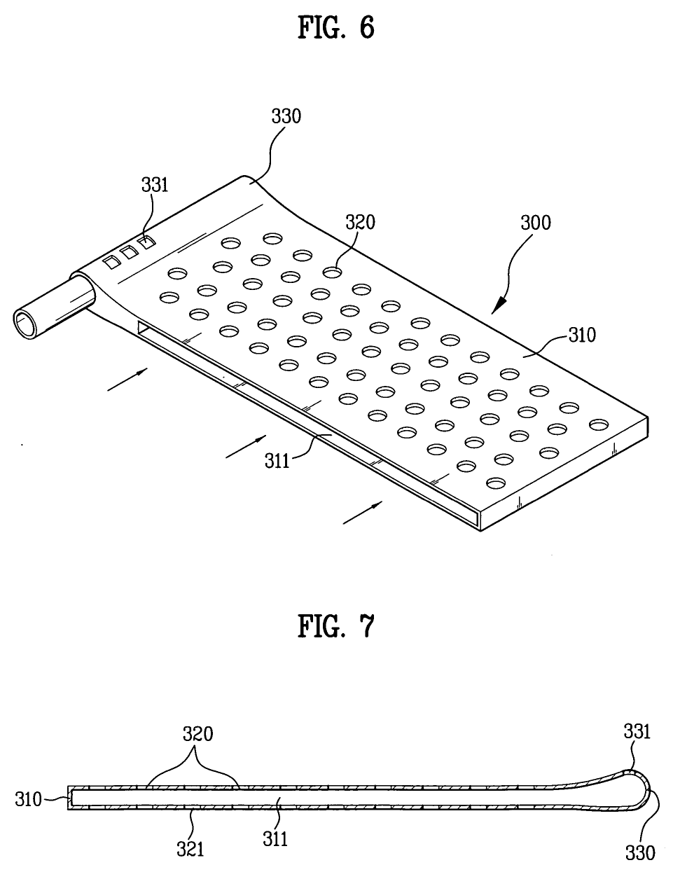

The lathe 300 according to an embodiment of the present invention, as shown in FIG. 5 and FIG. 6, includes a body part 310, a multitude of hot air outtakes 320 and a supplementary hot air supply pipe 330.

The body part 310 forms an exterior of the lathe 300. A space portion 311 is provided within the body part 310 to be supplied with hot air.

Preferably, a rear side of the body part 310 of the lathe 300 is configured open. This is to lead the hot air supplied to the inside of the body 210 of the cabinet dryer via each of the hot air outlets 241a to the space portion 311 provided within the body part 310 via the open side.

Namely, a portion of the hot air, as shown in FIG. 3, is supplied over the lathe 300 to dry an upper part of the laundry placed on the lathe 300. And, another portion of the hot air via a specific one of the hot air outlets 241a is supplied to the body part 310 via the opening at the rear side of the body part 310.

A multitude of the hot air outtakes 320 are provided to an upper side of the body part 310 to communicate with the space portion 311. And, a multitude of the hot air outtakes 320 play a role in blowing the hot air flowing in the space portion 311 to a lower side of the laundry placed on the body part 310.

Namely, the hot air outlet 241a, the opening of the lathe 300, the body part 310 of the lathe 300 and the hot air outtake 320 configure a passage for the flowing air. And, the hot air is supplied to the lower side of the laundry placed on the body part 310 via the passage.

Therefore, the upper and lower sides of the laundry can be evenly dried.

The supplementary hot air supply pipe 330 is provided to one end of the body part 310. The supplementary hot air supply pipe 330 detachably fixes the body part 310 to the inside of the cabinet dryer and plays a role in enabling the hot air to flow in part.

Preferably, the supplementary hot air supply pipe 330 is installed to communicate with the hot air inlet pipe 241.

At least one or more supplementary hot air outtakes 331 are provided to a circumference of the supplementary hot air supply pipe 330. The hot air flowing through the supplementary hot air supply pipe 330 is directly supplied to the laundry via the supplementary hot air outtake 331, whereby the drying process of the laundry can be carried out more smoothly.

Optionally, the supplementary hot air outtakes 331 are provided to a lateral side of the supplementary hot air supply pipe 330 to directly provide the hot air to the laundry hung on a lateral side of the lathe 300.

Meanwhile, one side of the supplementary hot air supply pipe 330 is preferably installed to communicate with the space portion 311 of the body part 310. This is to enable the hot air introduced into the supplementary hot air supply pipe 330 to flow to the space portion 311.

A multitude of lower hot air outtakes 321, as shown in FIG. 7, are preferably provided to a lower side of the body part 310 of the lathe 300 according to the embodiment of the present invention to blow the air introduced into the space portion 311 toward the laundry placed under the body part 310.

A hanging bar 222 is provided to one side space of an upper space within the body 210 of the cabinet dryer to hold a hanger and the like.

The control unit 400 of the present invention carries out an operation control of the drum type dryer 100 and the cabinet dryer 200.

The control unit 400 is provided to at least one of the drum type dryer 200 and the cabinet dryer 200. Preferably, the control unit 400, as shown in the embodiment o the present invention, is provided to the drum type dryer only.

If the control unit 400 is provided to each of the drum type dryer 100 and the cabinet dryer 200, it is preferable that a pair of the control units 400 are mutually connected together via a data cable (not shown in the drawings) to enable information exchange.

And, the control unit 400 can be configured to control the drum type dryer 100 and the cabinet dryer 200 separately or inter-operably.

A process of drying the laundry accommodated within the cabinet dryer of the above=explained complex type drying apparatus according to the embodiment of the present invention and actions corresponding to the drying process are explained in the following description. Since a drying process via the drum type dryer is not directly associated with the resent invention, the corresponding explanation will be skipped in the following description.

First of all, in case of attempting to perform a drying using the drying apparatus according to the present invention, and more particularly, the cabinet dryer, laundries are placed or hung on the lathe 300 and/or the hanging bar 222 provided within the body 210 of the cabinet dryer 200.

Power is then supplied to the hot air supply unit 130 to introduce hot air into the second hot air supply pipe 122 of the hot air supply pipe.

Subsequently, the valve 125 is adjusted so that the hot introduced into the second hot air supply pipe 122 can be introduced into the hot air inlet pipe 241 of the cabinet dryer.

A portion of the hot air introduced into the hot air inlet pipe 241 is introduced into the body 210 of the cabinet dryer via a plurality of the hot air outlets 241a, and another portion of the hot air is introduced into the supplementary hot air supply pipe 330.

In doing so, a portion of the hot air introduced into the body 210 of the cabinet dryer flows toward the laundry to dry an upper part of the laundry, while another portion of the hot air introduced into the body 210 of the cabinet dryer is introduced into the space portion 311 via the opening of the hot air drying lathe 300.

A portion of the hot air introduced into the supplementary hot air supply pipe 330 connected to the hot air inlet pipe 241 is blown toward the laundry via the supplementary hot air outtakes 331, while the rest of the hot air is introduced into the space portion 311 of the lathe 300.

A portion of the hot air introduced into the space portion 311 of the lathe 300 is blown to a lower side of the laundry via the hot air outtakes 320 provided to the upper side of the body part 310, while another portion of the hot air introduced into the space portion 311 of the lathe 300 is blown to an upper side of the laundry placed under the lathe 300 via the lower hot air outtakes 321 provided to the lower side of the body part 310.

Namely, by the hot air introduced into the body 210 of the cabinet dryer 200 and the hot air directly provided from the lathe 300, the upper and lower sides of the laundry can be evenly dried. And, it is able to prevent the laundry from being excessively dried in part.

Meanwhile, the humid air resulting from drying the laundries is introduced into the third supply pipe 123 via the air outlet pipe 242 provided to one side of the body 201 of the cabinet dryer.

The humid air having been introduced into the third supply pipe 123 passes through the condensing unit 140 so that moisture is removed from the humid air to generate a dry air. The dry air passes through the drying heater 131 to become hot air. The hot air is then re-supplied to the body 210 of the cabinet dryer 200.

The above-explained flow of the air is repeatedly carried out during a set time to dry the laundries.

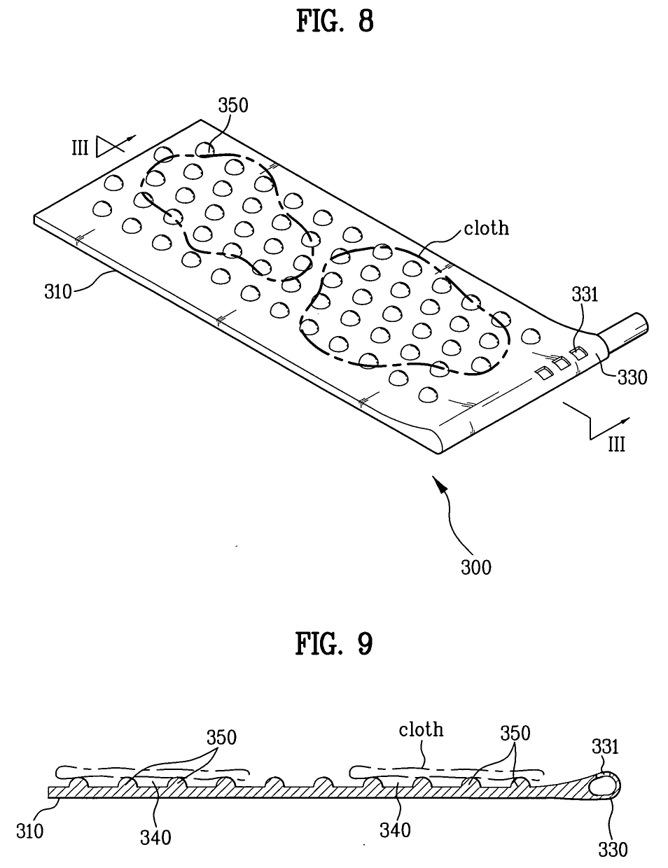

A complex type drying apparatus according to another embodiment of the present invention is explained with reference to FIG. 8 and FIG. 9 as follows.

Since the present embodiment differs from the former embodiment of the present invention in a detailed configuration of a lathe only, the same description of the former embodiment shall be skipped in the following description.

Referring to FIG. 8 and FIG. 9, a lathe according to another embodiment of the present invention includes a body part 310, a multitude of projections 350 and a supplementary hot air supply pipe 330.

The body part 310 forms an exterior of the lathe 300 but is not provided with the space portion of the lathe according to the former embodiment of the present invention.

A multitude of the projects 350 are projected from an upper surface of the body part 310 to support a laundry. Hence, when the laundry is placed on the lathe 300, a prescribed gap exists between the laundry and the upper surface of the lathe 300.

A hot air passing way 351 is formed along the gap between the laundry and the upper surface of the lathe and space between the respective projections 320 so that the hot air can pass through.

As the hot air flows through the hot air passing way 351, a lower side of the laundry can be dried.

Namely, in the present embodiment, the hot air can be supplied to the lower side of the laundry placed on the lathe via the hot air passing way 351 like the passage of the former embodiment for supplying the hot air to the lower side of the laundry.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A complex type drying apparatus, comprising:
a drum type dryer, comprising:
a drum accommodating a laundry;
a hot air supply pipe guiding a hot air to an inside of the drum; and
a hot air supply unit provided to a pipe path of the hot air supply pipe to generate the hot air;
a cabinet dryer provided over the drum type dryer, the cabinet dryer comprising:
an accommodating space for accommodating a laundry; and
a hot air inlet pipe supplied with the hot air from the hot air supply pipe to guide the received hot air to the accommodating space; and
at least one lathe provided within the cabinet dryer, the at least one lathe having a passage for supplying the hot air to a lower side of the laundry placed on the at least one lathe.

2. The complex type drying apparatus of claim 1, the at least one lathe comprising:
a body part having a space portion to be supplied with the hot air via the hot air inlet pipe, the body part forming an exterior of the at least one lathe; and
a multitude of hot air outtakes provided to an upper side of the body part to blow the hot air supplied to the space portion.

3. The complex type drying apparatus of claim 2, the body part comprising an opening provided to a rear side to enable the hot air to be supplied to the space portion via the hot air inlet pipe.

4. The complex type drying apparatus of claim 3, the at least one lathe further comprising a supplementary hot air supply pipe provided to one end of the body part to detachably fix the at least one lathe to an inside of the cabinet dryer and to be supplied with a portion of the hot air via the hot air inlet pipe.

5. The complex type drying apparatus of claim 4, wherein the supplementary hot air supply pipe communicates with the space portion of the body part.

6. The complex type drying apparatus of claim 5, wherein at least one supplementary hot air outtake is provided to a circumference of the supplementary hot air supply pipe to blow the supplied hot air.

7. The complex type drying apparatus of claim 2, the at least one lathe further comprising a multitude of lower hot air outtakes provided to a lower side of the body part to downwardly blow the hot air having been supplied to the space portion.

8. The complex type drying apparatus of claim 1, the at least one lathe comprising:
a body part forming a exterior of the at least one lathe; and
a multitude of projections projected from an upper surface of the body part to have the laundry spaced apart from the upper surface of the body part to form a passage for supplying the hot air to the lower side of the laundry.

9. The complex type drying apparatus of claim 8, the at least one lathe further comprising a supplementary hot air supply pipe provided to one end of the body part to detachably fix the at least one lathe to an inside of the cabinet dryer and to be supplied with a portion of the hot air via the hot air inlet pipe.

10. The complex type drying apparatus of claim 9, wherein at least one supplementary hot air outtake is provided to a circumference of the supplementary hot air supply pipe to blow the supplied hot air.

11. A complex type drying apparatus, comprising:
a drum type dryer, comprising:
a drum accommodating a laundry;
a hot air supply pipe guiding a hot air to an inside of the drum;
a hot air supply unit provided to a pipe path of the hot air supply pipe to generate the hot air; and
an air condensing unit provided to the pipe path of the hot air supply pipe, the air condensing unit condensing a flowing air to dissipate heat of the condensed air;
a cabinet dryer provided over the drum type dryer, the cabinet dryer comprising:
an accommodating space for accommodating a laundry;
a hot air inlet pipe supplied with the hot air from the hot air supply pipe to guide the received hot air to the accommodating space; and
an air outlet pipe guiding an air discharged from the accommodating space to the hot air supply pipe; and
at least one lathe provided within the cabinet dryer, the at least one lathe having a passage for supplying the hot air to a lower side of the laundry placed on the at least one lathe.

12. The complex type drying apparatus of claim 11, the hot air supplying unit comprising:
a drying heater heating the air flowing through the pipe path of the hot air supply pipe; and
a blower fan forcibly blowing the air within the hot air supply pipe.

13. The complex type drying apparatus of claim 12, wherein the blower fan is provided to an air intake side pipe path of the drying heater among the pipe paths of the hot air supply pipe by taking an air flowing direction as a reference.

14. The complex type drying apparatus of claim 11, the air condensing unit comprising:
a condenser supplied with the hot air from the hot air supply pipe to condense the hot air flowing through an inner pipe path of the condenser; and
a condensing fan blowing an external air toward the condenser.

15. The complex type drying apparatus of claim 11, the at least one lathe comprising:
a body part having a space portion to be supplied with the hot air via the hot air inlet pipe, the body part forming an exterior of the at least one lathe; and
a multitude of hot air outtakes provided to an upper side of the body part to blow the hot air supplied to the space portion.

16. The complex type drying apparatus of claim 15, the body part comprising an opening provided to a rear side to enable the hot air to be supplied to the space portion via the hot air inlet pipe.

17. The complex type drying apparatus of claim 15, the at least one lathe further comprising a supplementary hot air supply pipe provided to one end of the body part to detachably fix the at least one lathe to an inside of the cabinet dryer and to be supplied with a portion of the hot air via the hot air inlet pipe.

18. The complex type drying apparatus of claim 17, wherein the supplementary hot air supply pipe communicates with the space portion of the body part.

19. The complex type drying apparatus of claim 18, wherein at least one supplementary hot air outtake is provided to a circumference of the supplementary hot air supply pipe to blow the supplied hot air.

20. The complex type drying apparatus of claim 11, the at least one lathe comprising:
a body part forming a exterior of the at least one lathe; and
a multitude of projections projected from an upper surface of the body part to have the laundry spaced apart from the upper surface of the body part to form a passage for supplying the hot air to the lower side of the laundry.
